(19) United States
(12) Patent Application Publication
(10) Pub. No.: US 2008/0302652 A1
(43) Pub. Date: Dec. 11, 2008

(54) Particle Reduction Through Gas and Plasma Source Control

(75) Inventors: William Robert Entley, Wakefield, MA (US); Xing Chen, Lexington, MA (US); Ali Shajii, Canton, MA (US); Kaveh Bakhtari, Watertown, MA (US); Andrew Cowe, Andover, MA (US)

Correspondence Address: PROSKAUER ROSE LLP, ONE INTERNATIONAL PLACE, BOSTON, MA, 02110, US

(73) Assignee: MKS Instruments, Inc., Andover, MA (US)

(21) Appl. No.: 12/132,294

(22) Filed: Jun. 3, 2008

Related U.S. Application Data
(60) Provisional application No. 60/942,343, filed on Jun. 6, 2007.

(51) Int. Cl. H05H 1/24

(52) U.S. Cl. 204/157.15; 422/186.05

(57) ABSTRACT

A system for producing excited gases for introduction to a semiconductor processing chamber. The system includes a plasma source for generating a plasma. The plasma source includes a plasma chamber and a gas inlet for receiving process gases from a gas source. A gas flow rate controller is coupled to the gas inlet for controlling an inlet flow rate of the process gases from the gas source to the plasma chamber via the gas inlet. The system includes a control loop for detecting a transition from a first process gas to a second process gas and for adjusting the inlet flow rate of the second process gas from about 0 sccm to about 10,000 sccm over a period of time greater than about 300 milliseconds to maintain transient heat flux loads applied by the plasma to an inner surface of the plasma chamber below a vaporization temperature of the plasma chamber.

### CROSS-REFERENCE TO RELATED APPLICATIONS

This application claims the benefits of and priority to U.S. provisional patent application Ser. No. 60/942,343 filed on Jun. 6, 2007, the entire disclosure of which is herein incorporated by reference.

### FIELD OF THE INVENTION

The present invention relates to methods and apparatus for reducing particles generated by a remote plasma source.

### BACKGROUND OF THE INVENTION

Plasmas are often used to activate gases placing them in an excited state causing enhanced reactivity. The gases may be excited to produce dissociated gases containing ions, free radicals, atoms and molecules. Excited gases are used for numerous industrial and scientific applications, including processing solid materials such as semiconductor wafers and powders, other gases, and liquids. The parameters of the dissociated gas and conditions under which the dissociated gas interacts with a material to be processed by the system vary widely depending on the application. Excited gases are essential in many processes, such as photo-resist removal, wafer pre-clean operations, and thin film nitridation and oxidation operations. The charged particles in the excited gases, however, are sometimes undesirable because they interfere with the processes. To avoid these adverse effects, the plasma is sometimes generated remotely and the radicals are efficiently transported to the process chamber.

Plasma sources generate plasmas in various ways. For example, plasma sources generate plasma by applying an electric field in a plasma gas (e.g., O₂, NF₃, Ar, CF₄, N₂, H₂, and He) or a mixture of gases. Plasma sources may generate a plasma using a DC discharge, microwave discharge, or radio frequency (RF) discharge. A DC discharge generates a plasma by applying a potential between two electrodes in a plasma gas. A microwave discharge generates a plasma by directly coupling microwave energy through a microwave-transparent window into a discharge chamber containing a plasma gas. An RF discharge generates a plasma either by electrostatically or inductively coupling energy from a power supply to a plasma.

Plasmas are often contained in vessels that are composed of metallic materials such as aluminum, dielectric materials such as quartz or sapphire, or a combination of metallic and dielectric materials. The plasmas contained in the vessels sometimes interact with the inner surfaces of the vessels producing particles that are subsequently delivered to the process chamber. The particles adversely affect, for example, the process chamber walls and substrates located in the process chamber.

A need therefore exists for improved systems and methods for controlling the operation of a remote plasma source.

### SUMMARY OF THE INVENTION

The invention, in one aspect, features a system for producing excited gases for introduction to a semiconductor processing chamber. The system includes a plasma source for generating a plasma. The plasma source includes a plasma chamber. The system also includes a gas inlet for receiving process gases from a gas source. The system also includes a gas flow rate controller coupled to the gas inlet, for controlling an inlet flow rate of the process gases from the gas source to the plasma chamber via the gas inlet. The system also includes a control loop for detecting a transition from a first process gas (e.g., one or more gases) to a second process gas (e.g., one or more gases) and for adjusting the inlet flow rate of the second process gas from about 0 standard cubic centimeter per minute (sccm) to about 10,000 sccm over a period of time greater than about 300 milliseconds to maintain transient heat flux loads applied by the plasma to an inner surface of the plasma chamber below a vaporization temperature of the plasma chamber.

In some embodiments, the control loop controls an ignition sequence by igniting a plasma using a first gas, transitioning to a second gas, and transitioning to a final desired gas mixture while maintaining total gas flow rate above a minimum value. In some embodiments, the control loop controls a transition from a first gas mixture to a second gas mixture and a transition to a final desired gas mixture while maintaining total gas flow rate above a minimum value. In some embodiments, the system includes a showerhead or gas distribution system used to control gas input to the plasma chamber to protect the surface of the plasma chamber from plasma-surface interactions and gas-surface interactions in steady-state or transient operation of the remote plasma source.

In some embodiments, the plasma chamber includes a material selected from the group consisting of quartz, sapphire, alumina, aluminum nitride, yttrium oxide, anodized aluminum and aluminum. In some embodiments, the system includes an outlet for delivering the excited gases output to a semiconductor process chamber.

In some embodiments, the system includes a particle monitor coupled to the outlet to measure particles (e.g., silica particles) in the excited gases. In some embodiments, the control loop changes a flow property of the second process gas based on the particle monitor measurement. In some embodiments, the flow property is selected from the group consisting of flow rate and rate of change of flow rate. In some embodiments, the control loop changes composition of the second process gas based on the particle monitor measurement.

In some embodiments, the system includes a pressure sensor coupled to the plasma chamber. In some embodiments, the plasma chamber is a remote plasma chamber. In some embodiments, the control loop changes a flow property of the second process gas based on a signal output by the pressure sensor. In some embodiments, the flow property is selected from the group consisting of flow rate, flow volume and rate of change of flow rate.

In some embodiments, the system includes a power measurement module to measure at least one of power provided to the plasma source or duty cycle of a power supply for providing power to the plasma source. In some embodiments, the control loop changes a power supply output property based on a signal output by the power measurement module.

In some embodiments, the system includes a plasma property module to measure at least one of optical emission intensity of the plasma or photoemission intensity of the plasma. In some embodiments, the control loop changes at least one of a flow property of the second process gas or power supply output property based on a signal output by the plasma property module.

The invention, in another aspect, features a method for producing excited gases for introduction to a semiconductor processing chamber. The method includes generating a plasma in a quartz plasma chamber of a plasma source. The method also involves detecting a transition from a first process gas provided to the quartz plasma chamber to a second process gas provided to the quartz plasma chamber. The method also involves adjusting an inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.

In some embodiments, the method includes outputting the excited gases to a semiconductor process chamber via an outlet of the plasma chamber. In some embodiments, the method includes measuring particles (e.g., silica particles) in the excited gases with a particle monitor coupled to the outlet. In some embodiments, the method includes changing a flow property of the second process gas based on the particle monitor measurement. In some embodiments, the method includes changing composition of the second process gas based on the particle monitor measurement. In some embodiments, the method includes measuring gas pressure in the quartz plasma chamber. In some embodiments, the method includes changing a flow property of the second process gas based on the gas pressure.

In some embodiments, the method includes measuring at least one of power provided to the plasma source or duty cycle of a power supply for providing power to the plasma source. In some embodiments, the method includes changing a power supply output property based on a signal output by the power measurement module. In some embodiments, the method includes measuring at least one of optical emission intensity of the plasma or photoemission intensity of the plasma. In some embodiments, the method includes changing at least one of a flow property of the second process gas or power supply output property based on a signal output by the plasma property module.

In some embodiments, the method includes extinguishing the plasma for a period of time while transitioning from the first process gas provided to the quartz plasma chamber to the second process gas. In some embodiments, the period of time is greater than about 0.5 seconds. In some embodiments, the period of time is greater than about 10 seconds. In some embodiments, at least one of the first process gas or second process gas is allowed to flow through the plasma chamber while the plasma is extinguished. In some embodiments, the method also includes reigniting the plasma at the conclusion of the period of time.

The invention, in another aspect, features a system for producing excited gases for introduction to a semiconductor processing chamber. The system includes a plasma source for generating a plasma, wherein the plasma source includes a quartz plasma chamber. The system includes a gas inlet for receiving process gases from a gas source. The system includes a gas flow rate controller coupled to the gas inlet, for controlling an inlet flow rate of the process gases from the gas source to the plasma chamber via the gas inlet. The system also includes a control loop for detecting a transition from a first process gas to a second process gas and for adjusting the inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.

The invention, in another aspect, includes an apparatus for producing excited gases for introduction to a semiconductor processing chamber. The apparatus includes means for generating a plasma in a quartz plasma chamber of a plasma source. The apparatus includes means for detecting a transition from a first process gas provided to the quartz plasma chamber to a second process gas provided to the quartz plasma chamber. The apparatus includes means for adjusting an inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.

### BRIEF DESCRIPTION OF THE DRAWINGS

The foregoing and other objects feature and advantages of the invention, as well as the invention itself, will be more fully understood from the following illustrative description, when read together with the accompanying drawings which are not necessarily to scale.

FIG. 1 is a schematic illustration of a plasma processing system, according to an illustrative embodiment of the invention.

FIG. 2 is a schematic illustration of a plasma processing system that includes integrated process controls to minimize/eliminate transient plasma fluctuations that result in surface erosion, degradation, and particle generation in a plasma source, according to an illustrative embodiment of the invention.

FIG. 3 is a graphical representation of gas pressure as a function of time, according to an illustrative embodiment of the invention.

FIG. 4 is graphical representation of gas flow rate as a function of time, according to an illustrative embodiment of the invention.

FIG. 5 is graphical representation of the ratio of gas flow rates of a first feed gas relative to a second feed gas as a function of time, according to an illustrative embodiment of the invention.

FIG. 6 is graphical illustration of the experimental decrease in dP/dt when a feed gas flow rate is ramped in various ways, according to an illustrative embodiment of the invention.

FIG. 7 is a graphical illustration of output from an optical sensor and current in a primary coil of a toroidal plasma relative to time, using a plasma generation system that does not incorporate the invention.

FIG. 8 is a graphical illustration of output from an optical sensor and current in a primary coil of a toroidal plasma relative to time, using a plasma generation system that incorporates principles of the invention.

FIG. 9 is a graphical illustration of output from an optical sensor and current in a primary coil of a toroidal plasma relative to time, using a plasma generation system that incorporates principles of the invention.

### DETAILED DESCRIPTION OF ILLUSTRATIVE EMBODIMENTS

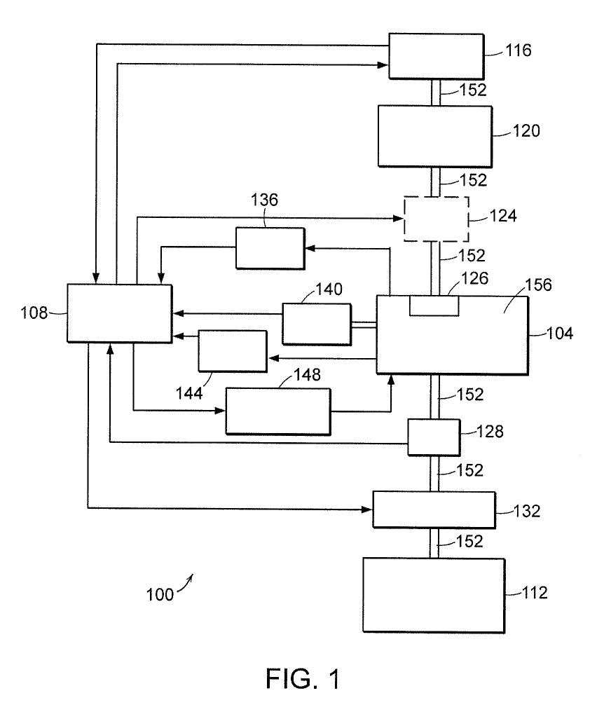

FIG. 1 is a schematic illustration of a plasma processing system 100 for producing excited gases that embodies the invention. The system 100 includes a remote plasma source 104 that is connected to a process chamber 112 by a gas pipeline 152. The system 100 includes a controller 108 (e.g., computer processor) that is coupled to various plasma processing components or subsystems that are used to operate the plasma processing system 100.

The system 100 includes a fluid supply system 116 that provides one or more gases or fluids to a chamber 152 of the remote plasma source 104 via the gas pipeline 152. The controller 108 provides a command signal to the fluid supply system 116 to vary properties of the gases or fluids provided by the fluid supply system 116 to the remote plasma source 104. In some embodiments, the fluid supply system 116 provides signals to the controller 108 that are used to, for example, monitor or alter the operation of the fluid supply system 116.

The fluid supply system 116 includes one or more fluid supply components (e.g., actuators and sensors). In one embodiment, the fluid supply system 116 includes a plurality of mass flow controller (MFC) devices that are used to measure and control the flow of operating gasses in the system 100. In one embodiment, the fluid supply system 116 includes a vapor supply device (e.g., a vapor on demand module (VoDM) manufactured by MKS Instruments, Inc., Wilmington, Mass.) that is used to generate a controlled flow of vapor (e.g., water vapor).

The system 100 includes an optional pre-mixing chamber 120 for pre-mixing one or more gases or fluids prior to introduction to the remote plasma source 104. Pre-mixing allows for properties (e.g., gas composition, pressure) to stabilize prior to introduction to the remote plasma source 104, which reduces fluctuations in the plasma (e.g., power density, location of the plasma relative to the inner surface of the chamber 156) in the remote plasma source 104. The system 100 also includes an optional pressure control device 124 for regulating or controlling the pressure of the one or more gases or fluids provided to the remote plasma chamber 104. A showerhead or a gas distribution system 126 can be installed at the gas inlet of remote plasma source 104 to control the pattern of gas flow into plasma chamber 156. The gas distribution system 126 facilitates the creation of a uniform plasma, reduction of fluctuations or instabilities in the gas flow and plasma, and protection of the surface of the plasma chamber from plasma-surface interactions and gas-surface interactions. The gas distribution system 126 directs a fraction of the inlet gas along the plasma chamber walls to form a gas blanket (or gas layer) on the walls to minimize plasma-surface interactions.

The remote plasma source 104 generates a plasma by applying an electric field in a plasma gas (e.g., O₂, NF₃, Ar, CF₄, N₂, H₂, and He) or a mixture of gases that are delivered to the chamber 156 by the fluid supply system 116 via the gas pipeline 152. The plasma chamber 156 can comprise a material selected from the group consisting of quartz, sapphire, alumina, aluminum nitride, yttrium oxide, anodized aluminum and aluminum. The type of material can be selected based on process chemistries. In some embodiments, the plasma chamber is fabricated using a material that is resistant to the plasma and excited gases produced in the remote plasma source 104 from a specific set of gases (e.g., process and plasma gases). Plasma sources may generate a plasma using a DC discharge, microwave discharge, or radio frequency (RF) discharge. A DC discharge generates a plasma by applying a potential between two electrodes in the plasma gas. A microwave discharge generates a plasma by directly coupling microwave energy through a microwave-transparent window into a discharge chamber containing the plasma gas. An RF discharge generates a plasma either by electrostatically or inductively coupling energy from a power supply to the plasma.

The remote plasma source 104 can include means for generating free charges that provide an initial ionization event that ignites the plasma in the chamber 156. The initial ionization event can be a short, high voltage pulse that is applied to the plasma chamber 156. The pulse can have a voltage of approximately 500-20,000 volts, and can be approximately 0.1 to 10 microseconds long. The initial ionization event may also be generated by use of a high voltage pulse of longer duration, approximately 10 microseconds to 3 seconds, which may be an RF pulse. An inert gas, such as argon, can be inserted into the chamber 156 to reduce the voltage required to ignite a plasma. Ultraviolet radiation can also be used to generate the free charges in the chamber 156 that provide the initial ionization event that ignites the plasma in the chamber 156.

In operation, the plasma generated in the chamber 156 of the remote plasma source 104 is used to activate gases (introduced by the fluid supply system 116) placing them in an excited state causing enhanced reactivity. The gases may be excited to produce dissociated gases containing ions, free radicals, atoms and molecules. Excited gases are used for numerous industrial and scientific applications, including processing solid materials such as semiconductor wafers and powders, other gases, and liquids. The parameters of the excited gases and conditions under which the excited gases interact with a material to be processed by the system 100 vary widely depending on the application. Excited gases are essential in many processes, such as photo-resist removal, wafer pre-clean operations, and thin film nitridation and oxidation operations.

The system 100 also includes one or more sensor modules that measure operating properties of the remote plasma source 104. In this embodiment, the system 100 includes a plasma property module 136, a pressure sensor 140 and a power measurement module 144. The modules (136, 140 and 144) provide measurement signals to the controller 108.

The plasma property module 136 is coupled to the remote plasma source 104 to measure operating properties of the plasma in the chamber 156. The plasma property module can be, for example, a system that measures optical emission intensity of the plasma or photoemission intensity of the plasma. The controller 108 can control the operation of the system 100 based on the intensity measurements. The pressure sensor 140 measures the pressure within the chamber 156 and can be used by the controller 108 to control the operation of the system (e.g., by varying the flow rate and volume of gases output by the fluid supply system 116). The power measurement module 144 is a means for measuring relevant electrical parameters of the plasma. Relevant electrical parameters of the plasma include the plasma current and power. The system 100 may also include an optical detector (not shown) for measuring the optical emission (e.g., spectrum or wavelengths or electromagnetic energy) from the plasma. The system 100 also includes a power supply 148 used to provide power to the remote plasma source 104.

In one embodiment, the remote plasma source 104 is an inductively-coupled remote plasma source that includes a power transformer that couples electromagnetic energy into the plasma. The power transformer includes a high permeability magnetic core and a primary coil. A plasma (e.g., a toroidal plasma) formed in the chamber 156 forms a secondary circuit of the power transformer. The power transformer can include additional magnetic cores and conductor primary coils that form additional secondary circuits. The power measurement module 144 may include a current probe positioned around the plasma chamber 156 to measure the plasma current flowing in the secondary of the power transformer. In addition, the controller 108 may accept data from the current probe and the optical detector and then adjusts the power in the plasma by adjusting the current in the primary winding.

The system 100 also includes a particle monitor 128 and a pressure control device 132. The particle monitor 128 detects particles output from the plasma chamber 156 via the gas pipeline 152. The particle monitor 128 provides signals to the controller 108. In one embodiment, the controller 108 outputs signals to one or more components (e.g., fluid supply system 116, power supply 148 or pressure control device 124) of the system 100. In this manner, the controller 108 can vary the operation of the system 100 to reduce the number of particles generated by the remote plasma source 104.

Embodiments of the invention are useful for minimizing adverse effects of plasma surface and gas surface interactions (e.g., surface erosion, particle generation, chemical contamination) due to gas and/or plasma fluctuations in a plasma source. Some embodiments of the invention are useful for minimizing particle generation from plasma sources, particularly in remote plasma sources designed for “on wafer” applications (e.g., the R*evolution remote plasma source, manufactured by MKS Instruments, Inc., Andover, Mass.). Some embodiments of the invention are useful for minimizing particle generation from a gas/liquid delivery system.

Some embodiments of the invention are useful for minimizing surface erosion (e.g., melting, vaporization, sublimation, sputtering), particle generation, and particle/residue buildup on the interior surfaces of a quartz plasma chamber (also referred to as the plasma applicator) in a remote plasma source. Embodiments of the invention are useful with hydrogen, oxygen or nitrogen based chemistries (e.g., H₂O, H₂, O₂, N₂) at high power levels; halogen based chemistries (e.g., NF₃, Cl₂, ClF₃); rapid cycling between H-based chemistries, O₂/N₂ based chemistries, and Ar ignition steps; and any applications involving cycling between chemistries (e.g., different gases and fluids) that generate particles.

Some embodiments of the invention are useful for minimizing surface erosion (e.g., melting, vaporization, sublimation, sputtering) and particle generation on the interior surfaces of anodized aluminum plasma chambers of plasma sources (e.g., the ASTRON plasma source, manufactured by MKS Instruments, Inc., Andover, Mass.) for hydrogen, oxygen or nitrogen based chemistries (e.g., H₂O, H₂, O₂, N₂) at high power levels; halogen based chemistries (e.g., NF₃, CF₄, C₂F₆, C₃F₈, SF₆, Cl₂, ClF₃); rapid cycling between halogen, hydrogen, oxygen or nitrogen based chemistries and Ar ignition steps.

It has been discovered that particle formation on the interior surface of a remote plasma source (e.g., the R*evolution plasma source offered for sale by MKS, Instruments, Inc.) may be caused by gas and plasma fluctuations during rapid changes in operating conditions, particularly the transitions between different process chemistries. The fluctuations occur when gases are introduced to a plasma, pushing the plasma to the plasma vessel surfaces, resulting in surface erosion and particle formation. These fluctuations and the associated surface erosion/particle generation can be eliminated and/or reduced by controlling the transition process. Gas introduction can be smoothed by gradually increasing and decreasing gas flow rates. The chamber pressure can be maintained at a stable level when gases are changed. The voltage, current and power level of the plasma source can be adjusted to minimize the fluctuations or the impact of the fluctuations.

In some embodiments, a time delay is introduced between process steps to further assist with reducing/eliminating gas and plasma fluctuations. In one embodiment which uses a remote plasma source for a remote passivation step of an aluminum interconnect photoresist process, a time delay is introduced between a H₂O plasma operating condition and an O₂/N₂ plasma operating condition. In one experiment, the introduction of the time delay between these two operating conditions significantly reduced the buildup of silica soot in the plasma chamber. This has the added benefit of reducing the amount of particulates that would be deposited on a wafer in a process chamber coupled to the output of the remote plasma source that would otherwise occur when the silica soot detaches from the surface of the plasma chamber during operation. In some embodiments, the time delay involves extinguishing the plasma for a period of time. In some embodiments, the time delay is about 15 seconds. In some embodiments, the time delay is between about 1 second and about 20 seconds. In some embodiments, the time delay is between about 0.1 seconds and about several minutes.

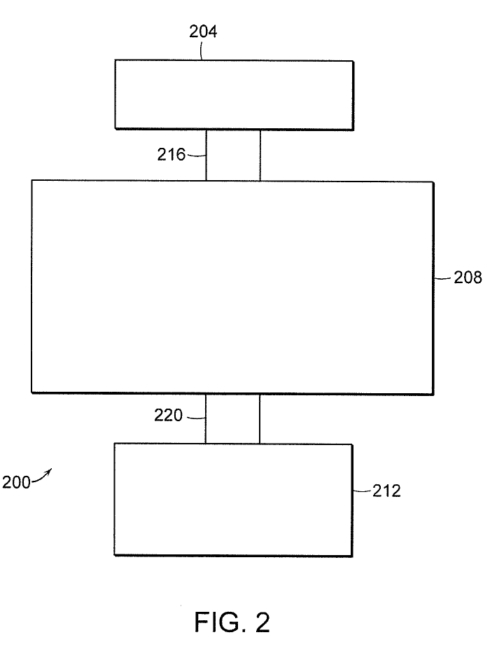

FIG. 2 is a schematic illustration of an embodiment of a plasma processing system 200 that incorporates principles of the present invention. The system 200 includes a process control module 204, a remote plasma source 208 and a process chamber 212. Various software, hardware, sensors and actuators are provided in the process control module 204. The system also includes a pressure control device 216 located between the process control module 204 and the remote plasma source 208. The system also includes a pressure control device 220 located between the remote plasma source 208 and the process chamber 212. The system 200 is adapted to permit fluids and gases to flow from the process control module 204 to the remote plasma source 208. The system is adapted to permit fluids and gases to flow from the remote plasma source 208 to the process chamber 212. In addition, the system 200 is adapted to permit electrical signals to travel between each of the process control module 204, remote plasma source 208, and the process chamber 212.

One aspect of the invention involves integrating in the plasma source or a process control module, the required hardware and software necessary to minimize/eliminate transient gas and plasma fluctuations in the plasma source that cause surface erosion, degradation, and particle generation. Various embodiments of the invention may include integrating control of the operating conditions in the plasma source. In one embodiment, various gas/vapor delivery modules (e.g., MFC's, VoDM) are integrated with the plasma source to provide for active control (e.g., adaptive control) of the gases/vapors to minimize/eliminate transient gas and plasma fluctuations in the plasma source. The gas/vapor delivery modules are incorporated into an integrated process control module (e.g., the process control module 204 of FIG. 2) that provides the feed gas to the remote plasma source.

In one embodiment, various components or modules (e.g., flow restrictors, throttle valves, proportional valves, orifices) are integrated into a process control module to provide for active pressure control in the plasma source to minimize/eliminate transient plasma fluctuations in the plasma source. In some embodiments, additional components are included in the system. In one embodiment, pressure control devices are included both upstream and downstream of the remote plasma source (e.g., the pressure control devices 216 and 218 of FIG. 2).

In one embodiment, various components or modules (e.g., premixing volume, premixing volume and flow restrictor (or variable flow restrictor)) are included upstream of the plasma source to buffer any changes in gas composition, pressure, or total flow rate to minimize/eliminate transient plasma fluctuations in the plasma source. The premixing volume and flow restrictor could be incorporated into an integrated plasma source control box (e.g., process control module 204 of FIG. 2) that provides the feed gases to the remote plasma source.

In one embodiment, the control algorithms used to operate the system are adapted to communicate and control the integrated hardware components (e.g., MFC's, throttle valves, power supplies) to minimize/eliminate transient plasma fluctuations as the plasma source is ignited, transitions to the user selected operating conditions (feed gas flow rates and power setpoint), and is finally extinguished.

In one embodiment, active control of gas flow conditions (flow rates, pressure, and gas compositions) as well as the plasma conditions (electric voltage, current and power) over operating conditions in the plasma source is provided to minimize/eliminate transient plasma fluctuations from the moment the plasma source is turned on until the moment the plasma source is turned off. By eliminating rapid changes in pressure and flow through the plasma source when the plasma source is off (idle), it is possible to also minimize transferring any particulates from the remote plasma source to, for example, a wafer in the process chamber. In some embodiments, a time delay is introduced between process steps to further assist with reducing/eliminating gas and plasma fluctuations.

In a remote plasma source that has a fused quartz (silica) plasma chamber (e.g., a R*evolution plasma source, MKS Instruments, Inc., Andover, Mass.), transient plasma-surface interactions can produce intense localized heat fluxes sufficient to volatilize monolayers of silica and generate silica soot. The production of soot can be chemistry-dependent. For example, the buildup of silica soot appears to be particularly problematic when rapidly cycling between H₂O-based plasmas and O₂/N₂-based plasmas. This silica soot can then flow into a process chamber and become deposited on wafers in the process chamber as particulates. One embodiment of the invention involves active control of the operating conditions in the remote plasma source to eliminate/avoid the operating conditions that result in such transient plasma-surface interactions. Transient plasma surface and gas surface interactions most often occur during rapid changes in, for example, power, input gas flow rate, input feed gas composition or pressure. Representative processes that could result in transient plasma-surface interactions include plasma ignition, transitions from plasma ignition to a process condition, transitions from a first process condition to a second process condition, and transitions from a process condition to RF OFF (which, extinguishes the plasma).

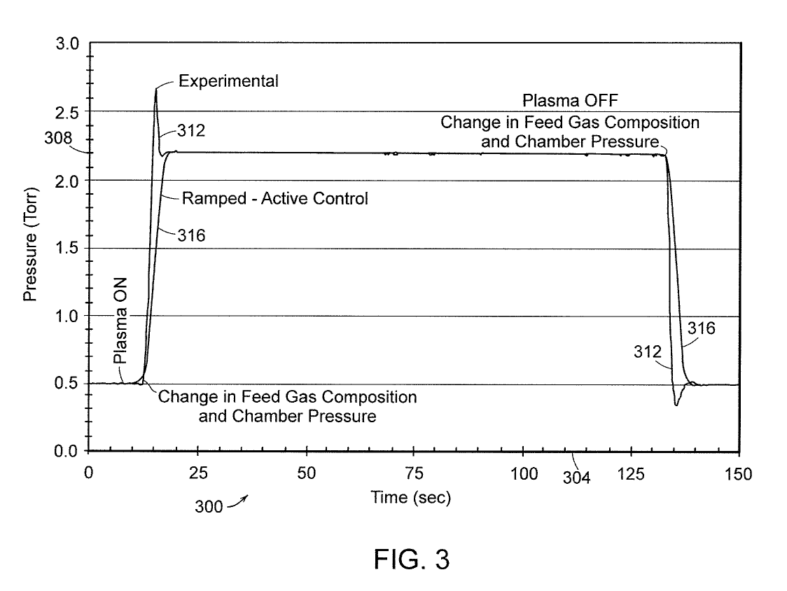

Various operating methods can be employed to eliminate/minimize such transient plasma-surface interactions. In one embodiment, active control of the pressure in the remote plasma source is performed to eliminate transient plasma surface interactions caused by rapid changes in operating conditions. FIG. 3 is a graphical representation of a plot 300 of gas pressure in a plasma chamber (e.g., the plasma chamber 156 of FIG. 1) as a function of time. The X-axis 304 of the plot 300 is time in units of seconds. The Y-Axis 308 of the plot 300 is pressure in units of Torr.

Curve 312 illustrates the change in pressure when the controller (e.g., controller 108) commands a rapid change in pressure from a value of approximately 0.5 Torr (setpoint 1) at about 12.5 seconds to a target pressure of 2.2 Torr (setpoint 2). Because the controller commands a rapid change in the pressure, the pressure in the plasma chamber overshoots the target value of 2.2 Torr to a value of about 2.7 Torr at about 15 seconds. The gas pressure approaches the value of 2.2 Torr at about 20 seconds. In addition, the controller commands a rapid change in pressure from a value of approximately 2.2 Torr (setpoint 2) at about 130 seconds to a target pressure of 0.5 Torr (setpoint 3). Because the controller commands a rapid change in the pressure, the pressure in the plasma chamber overshoots the target value of 0.5 Torr to a value of about 0.35 Torr at about 135 seconds. The gas pressure approaches the value of 0.5 Torr at about 140 seconds. The rapid changes in pressure when transitioning between different setpoints and the pressure transients associated with overshooting the target pressure values (setpoints) typically causes undesirable transient plasma-surface interactions.

Curve 316 illustrates the change in pressure when the controller (e.g., controller 108) commands a change in pressure from a value of approximately 0.5 Torr at about 12.5 seconds to a target pressure of 2.2 Torr, however, by application of principles of the present invention. A representative example of the desired smooth pressure transitions in the applicator is shown in FIG. 3. Because the controller commands a less rapid change in the pressure (the time is increased for a change in pressure from a first setpoint to a second setpoint), the pressure in the plasma chamber does not overshoot the target value of 2.2 Torr. The gas pressure approaches the value of 2.2 Torr at about 20 seconds. In addition, the controller commands a less rapid change in pressure from a value of approximately 2.2 Torr at about 130 seconds to a target pressure of 0.5 Torr. In addition, the pressure in the plasma chamber does not overshoot the target value of 0.5 Torr. The gas pressure approaches the value of 0.5 Torr at about 140 seconds. Because the change in pressure is not as rapid and the pressure transients have been reduced or eliminated, no substantial transient plasma-surface interactions are produced in the plasma chamber.

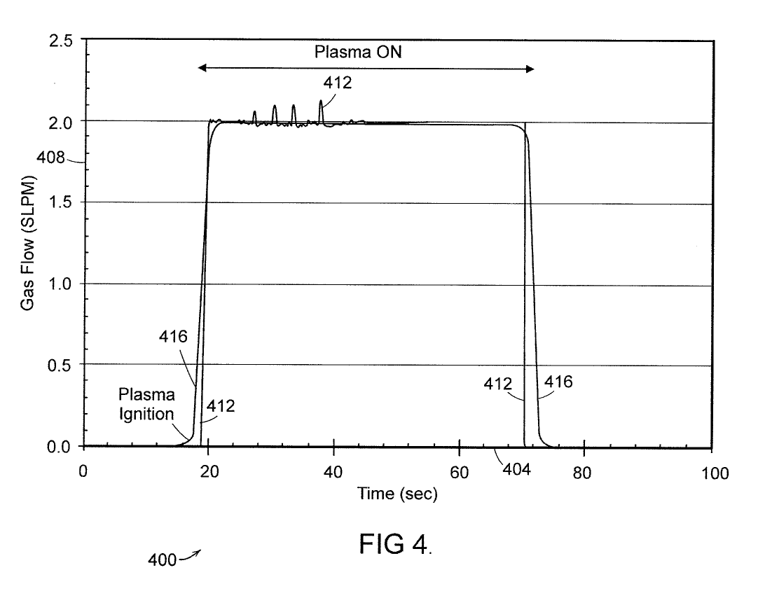

In another embodiment, active control of the gas flow rate in the remote plasma source is performed to eliminate transient plasma surface interactions caused by rapid changes in operating conditions. FIG. 4 is a graphical representation of a plot 400 of gas flow rate in a plasma chamber (e.g., the plasma chamber 156 of FIG. 1) as a function of time. The X-axis 404 of the plot 400 is time in units of seconds. The Y-Axis 408 of the plot 400 is gas flow in units of standard liters per minute (SLPM).

Curve 412 illustrates the change in gas flow rate when the controller (e.g., controller 108) commands a rapid change in gas flow rate from a value of approximately 0.0 SLPM at about 19 seconds to a target gas flow rate of 2.0 SLPM. Because the controller commands a rapid change in the gas flow rate, the gas flow rate in the plasma chamber varies (ripples of a about 0.1 SLPM) between about 20 seconds and about 45 seconds. In addition, the controller commands a rapid change in gas flow rate from a value of approximately 2.0 SLPM at about 70 seconds to a target gas flow rate of 0.0 SLPM. Because the controller commands a rapid change in the gas flow rate, the gas flow rate in the plasma chamber varies (ripples between 80 and 100 seconds) after reaching the target value of 0.0 SLPM. The gas flow rate transients (variation in gas flow rate) associated with commanding a rapid change in the gas flow rate typically causes undesirable transient plasma-surface interactions.

Curve 416 illustrates the change in gas flow rate when the controller (e.g., controller 108) commands a change in gas flow rate from a value of approximately 0.0 SLPM at about 16 seconds to a target gas flow rate of 2.0 SLPM, however, by application of principles of the present invention. A representative example of the desired smooth gas flow rate transitions in the applicator is shown in FIG. 4. The controller commands a less rapid change in the gas flow rate. In addition, the gas flow rate in the plasma chamber does not overshoot the target value of 2.0 SLPM. The gas pressure approaches the value of 2.0 SLPM at about 22 seconds. In addition, the controller commands a less rapid change in gas flow rate from a value of approximately 2.0 SLPM at about 68 seconds to a target gas flow rate of 0.0 SLPM. Because the controller commands a less rapid change in the gas flow rate, the gas flow rate in the plasma chamber does not vary after arriving at the target value of 0.0 Torr. Because the change in pressure is not as rapid and the gas flow rate transients have been reduced or eliminated, no substantial transient plasma-surface interactions are produced in the plasma chamber.

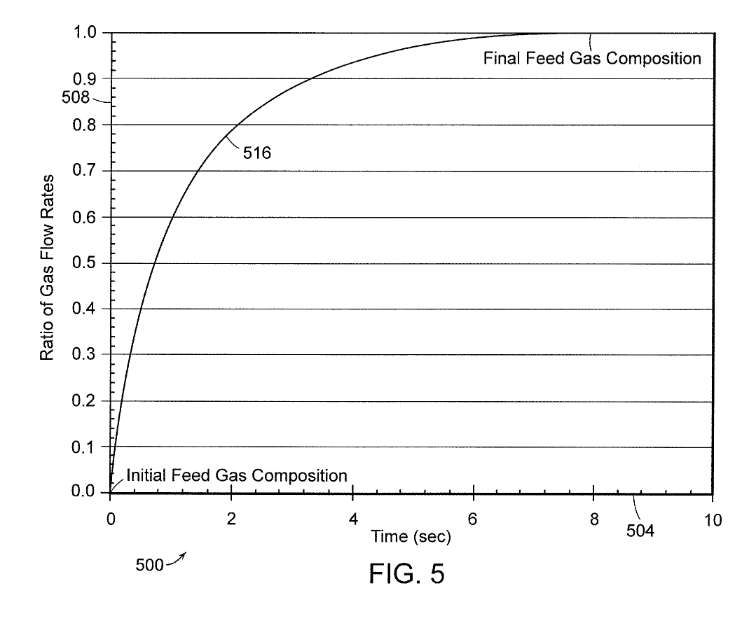

In another embodiment, active control of the ratio of a first feed gas (e.g. first process gas) relative to a second feed gas (e.g., second process gas) in the remote plasma source is performed to eliminate transient plasma surface interactions caused by rapid changes in operating conditions. FIG. 5 is a graphical representation of a plot 500 of the ratio between a first feed gas and a second feed gas in a plasma chamber (e.g., the plasma chamber 156 of FIG. 1) as a function of time. The X-axis 504 of the plot 500 is time in units of seconds. The Y-Axis 508 of the plot 500 is gas flow in non-dimensional units. A value of 0.0 on the Y-Axis means that only the first feed gas is present in the composition. A value of 1.0 on the Y-Axis means that the second feed gas flow rate is equal to the flow rate of the first feed gas. A value of 0.5 on the Y-Axis means that the composition (mixture of gas) is produced with the second feed gas provided at a gas flow rate that is 50% of the flow rate of the first feed gas.

Curve 516 illustrates the change in gas flow rate when the controller (e.g., controller 108) commands a change in the ratio of the first feed gas flow rate relative to the second feed gas flow rate from a value of 0.0 at about 0 seconds to a target ratio of 1.0 at about 7.2 seconds, in which principles of the present invention are utilized. Curve 516 is representative example of a desired smooth transition to be produced in the applicator. Because the controller commands a smooth, rather than a rapid (e.g., sudden step function change) change, transients will be reduced or eliminated, and no substantial transient plasma-surface interactions will be produced in the plasma chamber.

In some embodiments, the remote plasma source power is changed from an initial condition (e.g., off) to a desired setpoint in a time frame that allows for the fastest change in process conditions without causing transient plasma surface interactions.

In some embodiments, the plasma generation system includes a pre-mixing chamber (e.g., the pre-mixing chamber 120 of FIG. 1) to buffer the remote source from rapid changes in flow rates, gas composition, and pressure by pre-mixing the feed gases in the separate pre-mixing chamber upstream of the plasma source. In some embodiments a flow restrictor (or variable flow restrictor) is used between the pre-mixing chamber and the remote plasma source to control the flow of the mixed gases into the remote plasma source. The buffered gas flow mix is then introduced into the plasma source, thus minimizing/eliminating transient plasma fluctuations in the plasma source. In some embodiments, the pre-mixing chamber and flow restrictor are incorporated into an integrated plasma control module (e.g., the plasma control module 204 of FIG. 2) which provides the feed gases to the remote plasma source.

In some embodiments, a short delay is introduced between process steps to minimize plasma/gas fluctuations and plasma/gas surface interactions. In one embodiment, the plasma is extinguished (e.g., RF power is stopped) for about 10 seconds when transitioning from one operating condition (e.g., a first gas mixture) to another operating condition (e.g., a second gas mixture).

In some embodiments, the timing of the process steps is selected (by, for example, an operator) to minimize/eliminate transient plasma fluctuations in the plasma source. In some embodiments, the plasma is ignited after the gas flow rate and pressure in the remote plasma source is stable. In some embodiments, the gas flow and pressure in the plasma source is maintained at existing values for a short period of time after the plasma is extinguished. In some embodiments, the desired composition of a gas mixture is produced by introducing the individual feed gases sequentially into the plasma chamber.

In an integrated device, all operations described above could be completely performed by a controller (e.g., the controller 108 of FIG. 1) requiring little or no user input. For example, the user would simply enter the required power level, feed gas(es) types, feed gas flow rate(s), and process time for each step in the recipe and the integrated plasma source control would attain the desired operating conditions as quickly as possible while controlling the operating conditions in the plasma source to minimize/eliminate transient plasma surface interactions. As noted above, the integrated plasma source control could also control the process conditions after the plasma is turned off to minimize any pressure/flow transitions that could dislodge particulate matter from the interior of the remote plasma source.

It has been discovered that specific process recipes result in rapid degradation/erosion of and residue buildup on the interior surfaces of the quartz applicator in the MKS Instruments, Inc. R*evolution plasma generation system (Andover, Mass.). Experimental work has identified a cause of this rapid surface degradation and residue buildup to be transient gas surface and plasma surface interactions during process transitions (ignition, rapid changes in power, pressure, gas flow rate and composition, etc.).

An experiment was conducted to further illustrate the benefit of principles of the present invention. Optical images were compared of the inner surfaces of quartz applicators (tori) after exposure to various process conditions. The images were acquired using a digital camera attached to a flexible borescope. A first torus of a first plasma chamber was exposed to about 7063 cycles of a two step process at an applied power of approximately 5 kW, and RF power was applied to the plasma chamber over 216 hours. The two step process consisted of a H₂O plasma, followed by an O₂/N₂ plasma. Significant fluctuations in the plasma were visually observed as the plasma transitioned from the H₂O plasma process to the O₂/N₂ plasma process. A buildup of silica soot was observed on the surfaces of the first torus, particularly on the outer diameter surface of the torus. The silica soot consists of a large number of small particulates, each of which can flow out of the plasma chamber and be deposited in the process chamber (e.g., a semiconductor wafer located in the process chamber). It is therefore desirable to eliminate/minimize the formation of silica soot.

A second torus was exposed to about 7271 cycles of the same two step process (a H₂O plasma, followed by an O₂/N₂ plasma) at an applied power of approximately 5 kW, and RF power was applied to the plasma chamber over 177 hours. However, in this case, a time delay of 20 seconds was introduced between each process step (the H₂O plasma step was performed, a 20 second delay was introduced, the O₂/N₂ plasma step was performed, a 20 second delay was introduced, and this was repeated 7271 times). The introduction of the time delay between each process step minimized interactions between the plasma, gas, and plasma chamber surface. In this case, only small amounts of silica soot were observed on the surfaces of the plasma chamber (i.e., the surfaces of the toroidal plasma chamber), and of the silica soot observed, most of the soot was observed on the outer diameter surfaces of the toroidal plasma chamber. To verify that the process transitions between the H₂O plasma step and the O₂/N₂ plasma step were the cause of the buildup of soot in the experiment conducted on the first torus, a third experiment was conducted.

The third experiment involved exposing a third torus to about 21,891 cycles of the same two step process (a H₂O plasma, followed by an O₂/N₂ plasma) at an applied power of approximately 5 kW, and RF power was applied to the plasma chamber over 208 hours with no time delay between process steps. Each process step was conducted with the third torus for about ⅓ the amount of time as the process step was conducted with respect to the first torus (7271 cycles for the first torus/21,891 for the third torus). A larger soot buildup was observed in the third torus than was observed in either the first or second torus, thereby suggesting that the greater the number of process step transitions results in the production of more soot. The introduction of a time delay between process steps was shown to significantly reduce the production and buildup of soot.

Examples of ranges of operating conditions in remote plasma sources applicable to this invention include varying plasma chamber pressures between about 1 mTorr and about 20 Torr (or alternatively, maintaining a fixed chamber pressure during process transitions), feed gas flow rates between about 100 standard cubic centiliter per minute (sccm) to about 25 SLPM, plasma source power levels between about 100 W and about 20 kW, times over which operating parameters are varied (e.g., gas flow rates, applicator pressure) from about 0.1 seconds to about 20 seconds, gas mixing times between about 0.1 seconds and about 20 seconds, plasma source power densities between about 0.2 W/cm³ and about 60 W/cm³, and introducing a time delay (e.g., about 0.5 seconds) in which the RF power to the plasma is stopped between process steps (operating conditions). In some embodiments of the invention in which a time delay is introduced, gas may or may not be flowing through the plasma chamber.

Advantages of the present invention include allowing users to run specific process recipes with acceptable particle performance in plasma chambers that could not be run in other ways, providing a unified and integrated strategy to eliminate/minimize particle generation from remote plasma sources, reduce the need to optimize individual process recipes in remote plasma sources to minimize particle generation, address the root cause of particle generation in remote plasma sources (i.e., erosion of the applicator due to plasma-surface interactions), extending the useable lifetime of the plasma chamber, and identification of suitable operating conditions for a desired process chemistry that could not have been found merely via recipe optimization.

Various operating conditions lead to the vaporization of silica from the surface of a silica (quartz) plasma chamber. At atmospheric pressure, vitreous silica begins to vaporize above approximately 1350° C. The temperature at which this reaction occurs under vacuum is lower. Under normal operating conditions in an MKS Instruments, Inc. R*evolution remote plasma source, the experimentally measured heat fluxes at the inner surface of the torus are on the order of 15 W/cm², corresponding to a peak silica surface temperature of about 300° C. The transient gas/plasma surface interactions which result in the vaporization of silica can increase this heat flux by an order of magnitude (to approximately 130 W/cm²). It is also recognized that certain process recipes can change the composition and structure of the surface of the plasma chamber surface (e.g., the silica surface of the plasma chamber) which can alter the heat flux required to vaporize the plasma chamber surface. The formation of silica soot can also be related to surface chemical changes and the volatility and reactivity of different byproducts that occur as a result of rapidly alternating between different process steps (e.g., rapidly changing between H₂O plasma process steps and O₂/N₂ plasma process steps).

Rapid changes in pressure can result in transient gas/plasma surface interactions. Some embodiments of the invention alleviate this problem by using pressure control devices to minimize changes in pressure in the plasma source as a function of time (dP/dt).

Rapid changes in feed gas composition (e.g., ratio of mass flow rates) can result in transient gas/plasma surface interactions. Some embodiments of the invention alleviate this problem by ramping individual feed gas flow to minimize/eliminate rapid changes in feed gas composition during process recipe changes.

Rapid changes in feed gas flow rates (e.g., mass flow rates) can result in transient gas/plasma surface interactions. Some embodiments of the invention alleviate this problem by ramping feed gas flow rates to minimize/eliminate rapid changes in feed gas flow rates.

Rapid changes in power can result in transient gas/plasma surface interactions. Some embodiments of the invention alleviate this problem by ramping the delivered power to a desired setpoint to minimize/eliminate rapid changes in power during, for example, process recipe changes or ignition sequences.

Some ignition/shutdown conditions can result in transient gas/plasma surface interactions. Some embodiments of the invention alleviate this problem by optimizing ignition/shutdown conditions to minimize transient plasma-surface interactions using any combination of the above listed methods in any order, including using delay sequences between, for example, process steps.

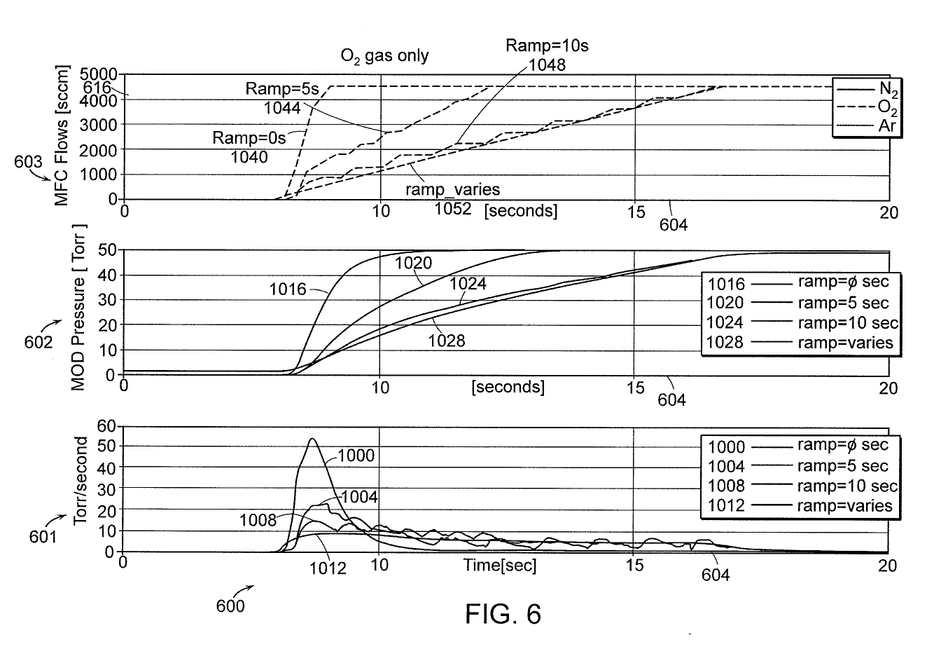

FIG. 6 is a graphical representation of data for an experiment that was conducted in which an MKS Instruments, Inc. Pressure Insensitive (PI) Control mass flow controller (MFC) flow rate of O₂ into a heated volume (i.e., a chamber maintained at 100° C.) was ramped from an initial value (initial setpoint) to a predefined setpoint. The heated volume was maintained at a temperature of 100° C. to prevent water vapor from condensing in the event water vapor was introduced into the volume. The heated volume was coupled to a plasma chamber (e.g., plasma chamber 156 of FIG. 1) having a volume of 1 liter. The plasma chamber was not operating in this experiment. The heated volume included a calibrated pressure transducer for measuring pressure (in this experiment it was a model 121 Baratron pressure transducer manufactured by MKS Instruments, Inc. or Andover, Mass.). The change in pressure relative to the change in time was calculated based on the measured pressure as a function of time using the pressure transducer.

Plot 601 is the change in pressure in the plasma chamber as function of time. The X-axis of plots 601, 602 and 603 is time in units of seconds. The Y-axis 608 of plot 601 is in units of Torr/second. Plot 602 is the pressure in the plasma chamber as function of time. The Y-axis 608 of plot 602 is in units of Torr. Plot 603 is flow rate of gas introduced into the plasma chamber. The Y-Axis 616 of plot 603 is in units of sccm.

Referring to plot 603, curve 1040 illustrates the change in flow rate of the O₂ into the plasma chamber in which the flow rate was not ramped up. Rather, the MFC was commanded to immediately change the flow rate from 0 sccm at about 8 seconds to the setpoint of 4500 sccm. The flow rate changed from 0 sccm to about 4500 sccm in approximately 1 second. Curve 1044 illustrates the change in flow rate of the O₂ into the plasma chamber in which the flow rate was ramped (in discrete increments/steps) up over a period of about 5 seconds. The MFC was commanded to ramp the flow rate up over a period of about 5 seconds from 0 sccm at about 8 seconds to the setpoint of 4500 sccm. Curve 1048 illustrates the change in flow rate of the O₂ into the plasma chamber in which the flow rate was ramped (in discrete increments/steps) up over a period of about 10 seconds. The MFC was commanded to ramp the flow rate up over a period of about 10 seconds from 0 sccm at about 8 seconds to the setpoint of 4500 sccm. Curve 1052 illustrates the change in flow rate of the O₂ into the plasma chamber in which the flow rate was ramped up (linearly ramped) over a period of about 10 seconds. The MFC was commanded to ramp the flow rate up over a period of about 10 seconds from 0 sccm at about 8 seconds to the setpoint of 4500 sccm.

Referring to plot 602, curve 1016 illustrates the pressure in the heated volume relative to time for the case in which the mass flow rate was commanded to change from 0 sccm to the setpoint of 4500 in which the flow rate was not ramped up (corresponding to curve 1040 of plot 603). Curve 1020 illustrates the change in pressure in the heated volume relative to time for the case in which the mass flow rate was commanded to change from 0 sccm to the setpoint of 4500 in which the flow rate was ramped up over a period of 5 seconds (corresponding to curve 1044 of plot 603). Curve 1024 illustrates the change in pressure in the heated volume relative to time for the case in which the mass flow rate was commanded to change from 0 sccm to the setpoint of 4500 in which the flow rate was ramped up over a period of 10 seconds (corresponding to curve 1048 of plot 603). Curve 1028 illustrates the change in pressure in the heated volume relative to time for the case in which the mass flow rate was commanded to change from 0 sccm to the setpoint of 4500 in which the flow rate was ramped up over a period of about 10 seconds (corresponding to curve 1052 of plot 603).

Referring to plot 601, curve 1000 illustrates the change in pressure in the plasma chamber relative to the change in time (dP/dt) as a result of the mass flow rate being commanded to change from 0 sccm to the setpoint of 4500 in which the flow rate was not ramped up. Curve 1004 illustrates the change in pressure in the plasma chamber relative to the change in time (dP/dt) as a result of the mass flow rate being commanded to change from 0 sccm to the setpoint of 4500 in which the flow rate was ramped up over a period of 5 seconds. Curve 1008 illustrates the change in pressure in the plasma chamber relative to the change in time (dP/dt) as a result of the mass flow rate being commanded to change from 0 sccm to the setpoint of 4500 in which the flow rate was ramped up over a period of 10 seconds. Curve 1012 illustrates the change in pressure in the plasma chamber relative to the change in time (dP/dt) as a result of the mass flow rate being commanded to change from 0 sccm to the setpoint of 4500 in which the flow rate was ramped up over a period of 10 seconds.

The decrease in dP/dt as the MFC ramp time is increased from 0 to 10 seconds is apparent. In addition, the optimized ramp sequence (ramp time of 10 seconds) reduces dP/dt by a factor of 5 (dP/dt decreased from a peak of about 52 Torr/second for 0 seconds of ramp time for curve 1000 compared with a peak of about 10 Torr/second for 10 seconds of ramp time for curve 1012). FIG. 6 also illustrates an additional aspect of this invention, namely that adaptive learning can be applied in the control system (e.g., the controller 108 of FIG. 1) to improve the performance of the system and reduce transient gas/plasma surface interactions that would otherwise occur in the plasma chamber. For example, in one embodiment, the control system includes an adaptive algorithm that continuously monitors dP/dt (or any other critical process parameter) and adjusts feed gas flow rate(s) ramp time(s) to minimize this parameter for a given process sequence.

In one embodiment, in one aspect, the invention involves controlling gas/plasma fluctuations that result in transient gas/plasma surface interactions during changes in operating conditions [ignition, recipe changes (e.g., pressure, flow, gas composition, and power), and RF OFF (e.g., extinguishing the plasma)]. In many cases the gas/plasma fluctuations can be visually observed in the plasma chamber (e.g., quartz applicator) as a flickering of the plasma, particularly at the inlet neck of the chamber (e.g., the inlet neck of the torus of a toroidal plasma chamber). An experiment was conducted to quantify gas/plasma fluctuation in a R*evolution remote plasma source (MKS Instruments, Inc., Andover, Mass.).

To quantify the gas/plasma fluctuation in the experiment, a New Focus Model 1801 visible DC-125 MHz low noise photoreceiver (wavelength range 300-1050 nm) (New Focus Inc., San Jose, Calif.) was fitted to outside of plasma chamber of the ASTRON remote plasma source such that the photoreceiver had line of sight access to the inlet neck on the quartz applicator. The output of the photoreceiver was captured on a Tektronix DPO 4104 Digital Phosphor Oscilloscope (Tektronix, Inc., Beaverton, Oreg.). To determine if power fluctuations occurred simultaneously with the transient gas/plasma fluctuations, a model 4997 Pearson Current Monitor (Pearson Electronics, Inc., Palo Alto, Calif.) was coupled to the primary coil of the inductively coupled remote plasma source. The output of the Pearson Current Monitor was also captured on a Tektronix DPO 4104 Digital Phosphor Oscilloscope.

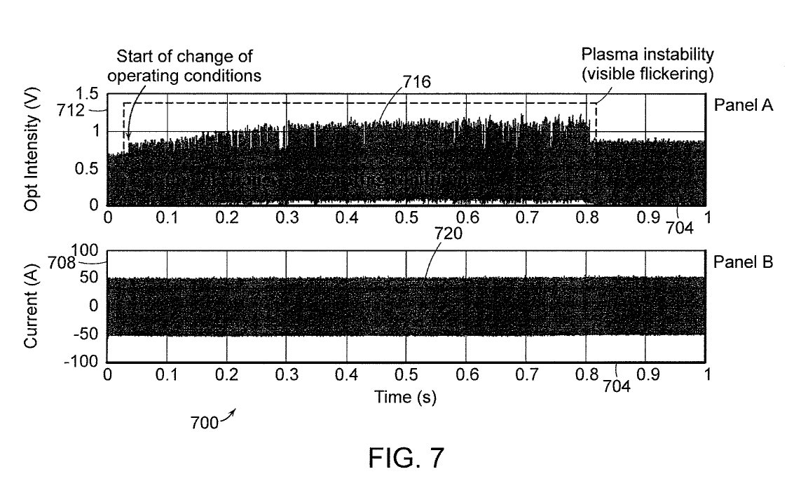

Panel A in FIG. 7 shows the optical sensor voltage from the New Focus photoreceiver during a process transition from operating condition 1 to operating condition 2. Panel A includes a curve 716 of optical intensity output versus time. The X-axis 704 is time in units of seconds. The Y-Axis 712 is optical intensity output in units of volts. The total gas flow rate for gas entering the plasma chamber for operating condition 1 is 2 SLPM, while the total gas flow rate for operating condition 2 is 5 SLPM. Operating condition 1 transitions to operating condition 2 starting at about 0.03 seconds. Prior to the transition, the output from the optical sensor is stable (left of the arrow in Panel A). As the transition occurs the plasma exhibits a visible flickering for approximately 0.8 seconds that is shown as the rapid fluctuations in the optical intensity in Panel A. This visible plasma flickering results primarily from a change in total flow rate in the operating conditions (a change from 2 SLPM to 5 SLPM). After about 0.8 seconds (at time 0.8 seconds along the X-Axis 704) the visible plasma flickering stops and the optical emission from the plasma is again stable. The visible flickering of the plasma is due to the transient gas/plasma fluctuations which results in transient gas/plasma interactions with the applicator surface. The transient gas/plasma interactions can volatilize monolayers of silica and generate silica soot. It is therefore desirable to eliminate such visible plasma flickering to minimize particle generation from the applicator. Curve 720 of Panel B shows that in this experiment, the current in the primary winding appears stable during the process transition, even though the plasma is in fact flickering. The X-axis 704 is time in units of seconds. The Y-Axis 708 is current in units of amps.

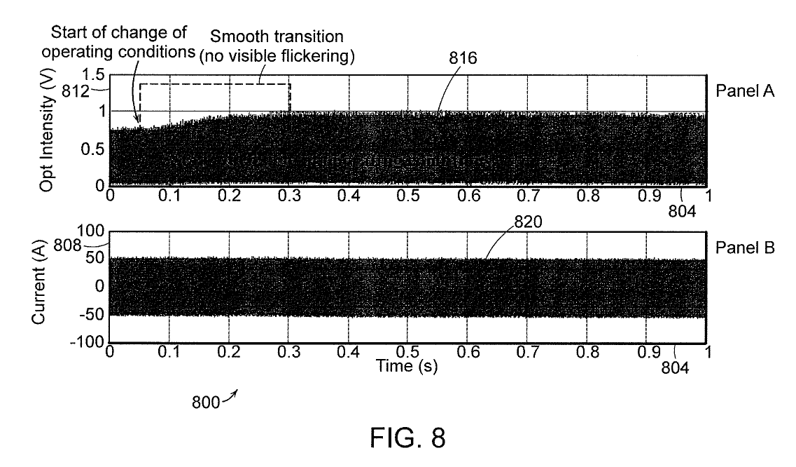

Panel A in FIG. 8 shows the optical sensor voltage during a process transition from operating condition 3 to operating condition 4. Panel A includes a curve 816 of optical intensity output versus time. The X-axis 804 is time in units of seconds. The Y-Axis 812 is optical intensity output in units of volts. Operating condition 3 transitions to operating condition 4 starting at about 0.05 seconds. The total gas flow rate for operating condition 3 is 0.5 SLPM, while the total gas flow rate for operating condition 4 is 2 SLPM. Prior to the transition, the output from the optical sensor is stable (left of the arrow in Panel A). As the transition occurs the plasma exhibits a smooth change in optical intensity for approximately 0.15 seconds (i.e., no visible flickering of the plasma is observed). In this case, by maintaining the total flow rate in the applicator below 2 SLPM, smooth transitions between operating conditions is achieved. Curve 820 of Panel B shows that the current in the primary appears stable during the process transition. The X-axis 804 is time in units of seconds. The Y-Axis 808 is current in units of amps.

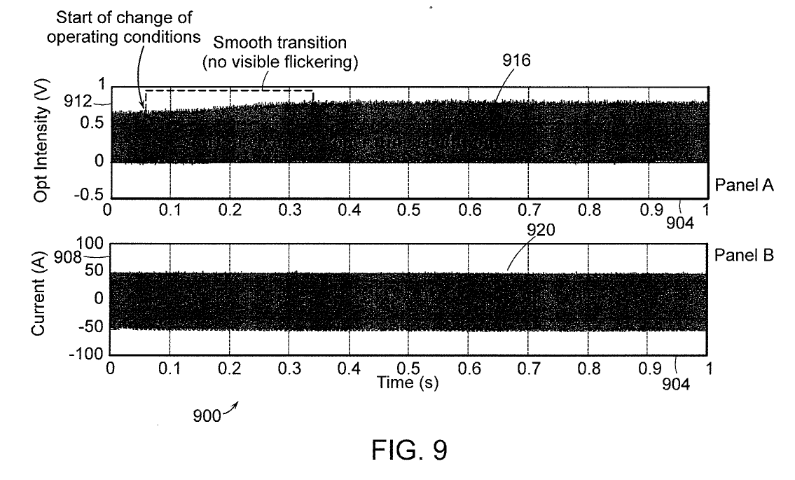

Panel A in FIG. 9 shows the optical sensor voltage during a process transition from operating condition 5 to operating condition 6. Operating condition 5 transitions to operating condition 6 starting at about 0.05 seconds. Panel A includes a curve 916 of optical intensity output versus time. The X-axis 904 is time in units of seconds. The Y-Axis 912 is optical intensity output in units of volts. The total gas flow rate for operating condition 5 is 4 SLPM, while the total gas flow rate for operating condition 6 is 5.5 SLPM. Prior to the transition the output from the optical sensor is stable (left of the arrow in Panel A). As the transition occurs the plasma exhibits a very smooth change in optical intensity for approximately 0.2 seconds (i.e., no visible flickering of the plasma is observed). In this case, by maintaining the total flow rate in the applicator greater than 4 SLPM, smooth transitions between operating conditions can be achieved. Curve 920 of Panel B shows that the current in the primary appears stable within experimental uncertainties during the process transition. The X-axis 904 is time in units of seconds. The Y-Axis 908 is current in units of amps.

The data in FIGS. 7-9 illustrate that controlling the total flow rate in the remote applicator is an important method for eliminating transient gas/plasma surface interactions that generate silica soot. These transitions can be further improved by ramping the flow between different operating conditions, as described previously herein. Additional methods exist to mitigate gas/plasma surface interactions, including, 1) turning the plasma off between recipe steps that are not compatible and would otherwise create, for example, large variations in pressure versus time (dP/dt); 2) maintaining the total flow rate above or below a critical threshold during recipe transitions (e.g., above 5 SLPM or below 2 SLPM as described above with respect to FIG. 7); 3) igniting above a critical threshold that would lead to visible plasma flickering (e.g., igniting at 4 SLPM in FIG. 9 and then transitioning to 5 SLPM); 4) igniting below a critical threshold that would lead to visible plasma flickering (e.g., igniting at 0.5 SLPM in FIG. 8 and then transitioning to 2 SLPM); 5) limiting the power provided to the remote plasma source during process transitions to minimize heat flux that could be generated by the plasma which could vaporize the surface of the plasma chamber (for example, reducing or providing power to the remote plasma source at levels less than about 1 kW); and 6) transitioning from high to low gas flows using Ar as the process gas (an Ar plasma is only able to accept up to about 1.1 kW of power due to the inherently low impedance of an Ar plasma; thereby limiting the amount of energy the plasma could apply to the plasma chamber).

In one embodiment, transitioning from high to low gas flow rates using Ar as the process gas is beneficial for minimizing transient gas/plasma fluctuations. Using Ar as the process gas, even at high flow rates, limits the total power in the R*evolution to about 1.2 kW. Thus, plasma fluctuations/flickering resulting in gas/plasma surface interactions would be significantly less damaging to the applicator surface when transitioning from high to low flow rates using Ar the feed gas compared to using a different gas mixture that would consume significantly more power (for example, operating conditions that are conducted at 5 kW or greater). In one embodiment, a transition from a low flow rate operating condition (e.g., inputting a process gas at about 500 sccm) to a high flow rate operating condition (e.g., inputting a process gas at about 5000 sccm) would benefit from operating the plasma generation system by 1) transitioning the feed gas to 100% Ar at the low flow rate (for example, switch from 500 sccm O2 to 500 sccm Ar); 2) ramping the total flow to the desired setpoint (i.e., ramp the Ar flow from 500 sccm to 5000 sccm), the plasma fluctuations during this step will occur at a maximum power of approximately 1.2 kW (instead of the 5 kW or greater that would be consumed by alternative feed gases); and 3) transitioning the feed gas mixture from Ar to the desired feed gas while maintaining a high total flow rate.

Variations, modifications, and other implementations of what is described herein will occur to those of ordinary skill in the art without departing from the spirit and the scope of the invention and are considered to be encompassed thereby. Accordingly, the invention is not to be defined only by the preceding illustrative description.

What is claimed is:

1. A system for producing excited gases for introduction to a semiconductor processing chamber, comprising:
a plasma source for generating a plasma, the plasma source comprising a plasma chamber;
a gas inlet for receiving process gases from a gas source;
a gas flow rate controller coupled to the gas inlet, for controlling an inlet flow rate of the process gases from the gas source to the plasma chamber via the gas inlet; and
a control loop for detecting a transition from a first process gas to a second process gas and for adjusting the inlet flow rate of the second process gas from about 0 sccm to about 10,000 sccm over a period of time greater than about 300 milliseconds to maintain transient heat flux loads applied by the plasma to an inner surface of the plasma chamber below a vaporization temperature of the plasma chamber.

2. The system of claim 1, wherein the control loop controls an ignition sequence by igniting a plasma using a first gas, transitioning to a second gas, and transitioning to a final desired gas mixture while maintaining total gas flow rate above a minimum value.

3. The system of claim 2, wherein the control loop controls a transition from a first gas mixture to a second gas mixture and a transition to a final desired gas mixture while maintaining total gas flow rate above a minimum value.

4. The system of claim 1, comprising a showerhead or gas distribution system used to control gas input to the plasma chamber to protect the surface of the plasma chamber from plasma-surface interactions and gas-surface interactions in steady-state or transient operation of the remote plasma source.

5. The system of claim 1, wherein the plasma chamber comprises a material selected from the group consisting of quartz, sapphire, alumina, aluminum nitride, yttrium oxide, anodized aluminum and aluminum.

6. The system of claim 1, wherein the plasma source comprises an outlet for delivering the excited gases output to a semiconductor process chamber.

7. The system of claim 6, comprising a particle monitor coupled to the outlet to measure particles in the excited gases.

8. The system of claim 7, wherein the control loop changes a flow property of the second process gas based on the particle monitor measurement.

9. The system of claim 8, wherein the flow property is selected from the group consisting of flow rate and rate of change of flow rate.

10. The system of claim 7, wherein the control loop changes composition of the second process gas based on the particle monitor measurement.

11. The system of claim 6, comprising a pressure sensor coupled to the plasma chamber.

12. The system of claim 11, wherein the control loop changes a flow property of the second process gas based on a signal output by the pressure sensor.

13. The system of claim 12, wherein the flow property is selected from the group consisting of flow rate, flow volume and rate of change of flow rate.

14. The system of claim 6, comprising a power measurement module to measure at least one of power provided to the plasma source or duty cycle of a power supply for providing power to the plasma source.

15. The system of claim 14, wherein the control loop changes a power supply output property based on a signal output by the power measurement module.

16. The system of claim 6, comprising a plasma property module to measure at least one of optical emission intensity of the plasma or photoemission intensity of the plasma.

17. The system of claim 16, wherein the control loop changes at least one of a flow property of the second process gas or power supply output property based on a signal output by the plasma property module.

18. The system of claim 1, wherein the second process gas comprises one or more gases.

19. The system of claim 1, wherein the plasma source is a remote plasma source.

20. A method for producing excited gases for introduction to a semiconductor processing chamber, the method comprising:
generating a plasma in a quartz plasma chamber of a plasma source;
detecting a transition from a first process gas provided to the quartz plasma chamber to a second process gas provided to the quartz plasma chamber; and
adjusting an inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.

21. The method of claim 20, comprising outputting the excited gases to a semiconductor process chamber via an outlet of the plasma chamber.

22. The method of claim 21, comprising measuring particles in the excited gases with a particle monitor coupled to the outlet.

23. The method of claim 22, comprising changing a flow property of the second process gas based on the particle monitor measurement.

24. The method of claim 22, comprising changing composition of the second process gas based on the particle monitor measurement.

25. The method of claim 21, comprising measuring gas pressure in the quartz plasma chamber.

26. The method of claim 25, comprising changing a flow property of the second process gas based on the gas pressure.

27. The method of claim 21, comprising measuring at least one of power provided to the plasma source or duty cycle of a power supply for providing power to the plasma source.

28. The method of claim 27, comprising changing a power supply output property based on a signal output by the power measurement module.

29. The method of claim 21, comprising measuring at least one of optical emission intensity of the plasma or photoemission intensity of the plasma.

30. The method of claim 20, comprising changing at least one of a flow property of the second process gas or power supply output property based on a signal output by the plasma property module.

31. The method of claim 20, comprising extinguishing the plasma for a period of time while transitioning from the first process gas provided to the quartz plasma chamber to the second process gas.

32. The method of claim 31, wherein the period of time is about 15 seconds.

33. The method of claim 31, wherein the period of time is between about 1 second and about 20 seconds or between about 0.1 seconds and about several minutes.

34. The method of claim 31, wherein at least one of the first process gas or second process gas is allowed to flow through the plasma chamber while the plasma is extinguished.

35. The method of claim 31, comprising reigniting the plasma at the conclusion of the period of time.

36. A system for producing excited gases for introduction to a semiconductor processing chamber, comprising:
a plasma source for generating a plasma, the plasma source comprising a quartz plasma chamber;
a gas inlet for receiving process gases from a gas source;
a gas flow rate controller coupled to the gas inlet, for controlling an inlet flow rate of the process gases from the gas source to the plasma chamber via the gas inlet; and
a control loop for detecting a transition from a first process gas to a second process gas and for adjusting the inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.

37. An apparatus for producing excited gases for introduction to a semiconductor processing chamber, the apparatus comprising:
means for generating a plasma in a quartz plasma chamber of a plasma source;
means for detecting a transition from a first process gas provided to the quartz plasma chamber to a second process gas provided to the quartz plasma chamber; and
means for adjusting an inlet flow rate of the second process gas from about 0 sccm to about 10,000 sccm over a period of time greater than about 300 milliseconds to maintain transient heat flux loads applied by the plasma to an inner surface of the quartz plasma chamber below a vaporization temperature of the quartz plasma chamber.
